(19) United States
(12) Patent Application Publication
(10) Pub. No.: US 2013/0111432 A1
(43) Pub. Date: May 2, 2013

(54) VALIDATION OF A SYSTEM MODEL INCLUDING AN ACTIVITY DIAGRAM

(71) Applicants: ERAN GERY, REHOVOT (IL); EHUD HOGGEG, REHOVOT (IL); BEERY HOLSTEIN, REHOVOT (IL); ELDAD PALACHI, BEER YAAKOV (IL); ALEXANDER REKHTER, REHOVOT (IL)

(72) Inventors: ERAN GERY, REHOVOT (IL); EHUD HOGGEG, REHOVOT (IL); BEERY HOLSTEIN, REHOVOT (IL); ELDAD PALACHI, BEER YAAKOV (IL); ALEXANDER REKHTER, REHOVOT (IL)

(73) Assignee: INTERNATIONAL BUSINESS MACHINES CORPORATION, ARMONK, NY (US)

(21) Appl. No.: 13/561,791

(22) Filed: Jul. 30, 2012

Related U.S. Application Data
(63) Continuation of application No. 13/287,377, filed on Nov. 2, 2011.

(51) Int. Cl. G06F 9/45

(52) U.S. Cl. 717/104

(57) ABSTRACT

Validating a system model. An embodiment can include receiving the system model. The system model can include at least one activity diagram. Via a processor, computer-readable program code corresponding to the system model, including the at least one activity diagram of the system model, can be generated. The computer-readable program code can be executed, and the execution of the computer-readable program code can be analyzed to perform a validation of the system model. A result of the validation can be output.

### BACKGROUND

One or more embodiments disclosed within this specification relate to validation of a system model.

UML is a standardized general-purpose modeling language in the field of object-oriented software engineering, and UML includes a set of graphic notation techniques to create visual models of object-oriented software-intensive systems. UML may be used, for example, to specify, visualize, modify, construct and document the artifacts of an object-oriented software-intensive system under development. In this regard, UML offers a standard way to visualize a system's architectural blueprints, including elements such as activities, actors, business processes, database schemas, logical components.

System Modeling Language (SysML) is a modeling language for systems engineering. SysML is defined as an extension of a subset of UML 2 using UML's profile mechanism. SysML reuses seven of UML 2's thirteen diagram types, and adds two diagram types, requirements and parametric diagrams, for a total of nine diagram types. SysML also supports allocation tables, a tabular format that can be dynamically derived from SysML allocation relationships.

Activity diagrams are commonly used by systems and software engineers to design their systems in UML and SysML. Activity diagrams are used to specify functional behaviors of UML and SysML design elements, such as use cases, blocks, classes and operations. The functional behaviors specified by activity diagrams typically are transformational in nature. For example, a functional behavior may represent a sequence of actions that convert input values to output values.

Activity diagrams also may be used to describe an independent behavior that coordinates the behaviors of such design elements. In this regard, these design elements may relate to other elements whose behavior might be described by a UML statemachine diagram, programming language code, or another activity diagram. In contrast to an activity diagram, a statemachine typically is designed to describe reactive behavior of design elements.

### BRIEF SUMMARY

One or more embodiments disclosed within this specification relate to validating a system model. An embodiment can include receiving the system model. The system model can include at least one activity diagram. Via a processor, computer-readable program code corresponding to the system model, including the at least one activity diagram of the system model, can be generated. The computer-readable program code can be executed, and the execution of the computer-readable program code can be analyzed to perform a validation of the system model. A result of the validation can be output.

Another embodiment can include receiving the system model. The system model comprising at least one activity diagram. Via a processor, computer-readable program code corresponding to the system model, including the at least one activity diagram of the system model, can be generated. The computer-readable program code can be compiled to generate at least one executable file. The executable file can be executed, and the execution of the executable file can be analyzed to perform a validation of the system model. A result of the validation can be output.

Another embodiment can include a system for validating a system model. The system can include a processor configured to perform executable operations and/or functions disclosed within this specification.

Another embodiment can include a computer program product for validating a system model. The computer program product can include a computer-readable storage medium having computer-readable program code embodied therewith, the computer-readable program code configured to perform the various operations and/or functions disclosed within this specification.

### BRIEF DESCRIPTION OF THE SEVERAL VIEWS OF THE DRAWINGS

FIG. 1 is a block diagram illustrating a system for validating a system model in accordance with one embodiment of the present invention.

FIG. 2 is a flow diagram illustrating a process of validating a system model in accordance with one embodiment of the present invention.

FIG. 3 is a flow chart illustrating a method of validating a system model in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing.

In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments described herein relate to a method and a system for validating a system model, such as a system model generated using Unified Modeling Language (UML) or System Modeling Language (SysML). The system can analyze a system model that includes one or more activity diagrams. An “activity diagram,” as used herein, is a UML or SysML diagram that specifies functional behaviors of UML and/or SysML design elements, such as use cases, blocks, classes and operations. The system automatically can generate computer-readable program code corresponding to the system model, including the activity diagram(s), and compile the computer-readable program code to generate one or more executable files. The executable files can be executed by the system, and analyzed to perform a validation of the computer-readable program code. The system further can output a result of the validation.

In addition, while the system executes the executable files, the system can present an animated model of the activity diagrams and control execution steps defined by the executable files. For example, the system can pause execution at various steps to receive user inputs to test the system model. In this manner, a software engineer or programmer can test and/or debug the system defined by the system model.

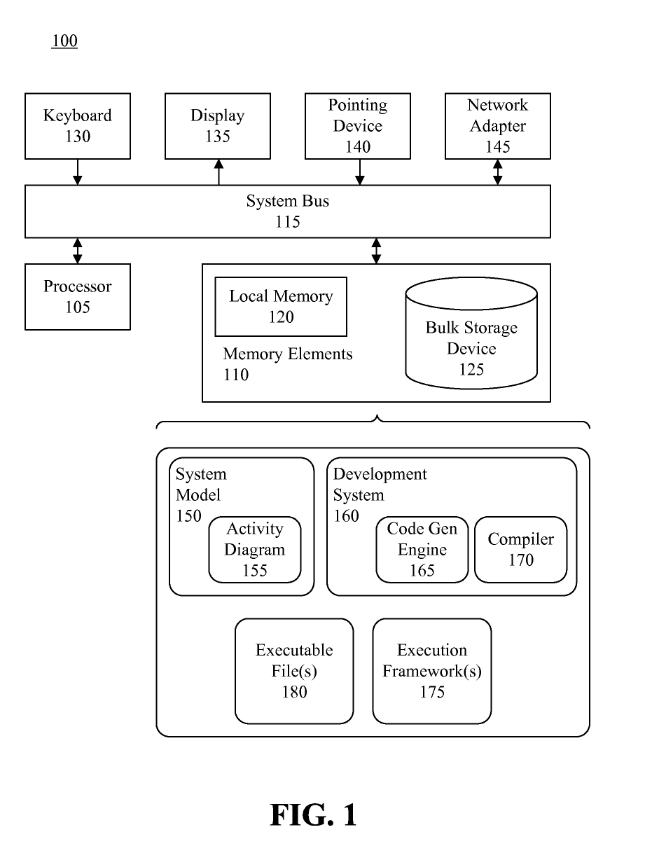

FIG. 1 is a first block diagram illustrating a system 100 for validating a system model in accordance with one embodiment of the present invention. The system 100 can include at least one processor 105 coupled to memory elements 110 through a system bus 115. As such, the system 100 can store computer-readable program code (hereinafter “program code”) within the memory elements 110. The processor 105 can execute the program code accessed from the memory elements 110 via the system bus 115. In one aspect, for example, the system 100 can be implemented as computer that is suitable for storing and/or executing program code. It should be appreciated, however, that the system 100 can be implemented in the form of any system comprising a processor and memory that is capable of performing the functions described within this specification.

The memory elements 110 can include one or more physical memory devices such as, for example, local memory 120 and one or more bulk storage devices 125. Local memory 120 refers to random access memory or other non-persistent memory device(s) generally used during actual execution of the program code. The bulk storage device(s) 125 can be implemented as a hard drive or other persistent data storage device. The system 100 also can include one or more cache memories (not shown) that provide temporary storage of at least some program code in order to reduce the number of times program code must be retrieved from the bulk storage device 125 during execution.

Input/output (I/O) devices such as a keyboard 130, a display 135, a pointing device 140 and a network adapter 145 optionally can be coupled to the system 100. The I/O devices can be coupled to the system 100 either directly or through intervening I/O controllers. The network adapter 145 can enable the system 100 to become coupled to other systems, computer systems, remote printers, and/or remote storage devices through intervening private or public networks. Modems, cable modems, and Ethernet cards are examples of different types of network adapters 145 that can be used with the system 100.

As pictured in FIG. 1, the memory elements 110 can store a system model 150 and a development system 160. The deployment system 160, being implemented in the form of executable program code, can be executed by the system 100 (e.g., via the processor 105), to perform the methods, processes and functions described herein.

The system model 150 can be a UML or SysML system model. The system model 150 can be generated by a user, such as a software engineer, systems engineer or computer programmer, using a suitable system modeling application, such as the development system 160. The system model 150 can include at least one activity diagram 155. The system model 150 further can include other types of UML and/or SysML diagrams.

The memory elements 110 also can store at least one execution framework 175. The execution frameworks 175 can be embodied as one or more programming language libraries. For example, an execution framework 175 can be provided for the C++ programming language, an execution framework 175 can be provided for the Java™ programming language, and so on. Each execution framework 175 can define items commonly used to create system models 150 in the respective programming languages. For example, each execution framework 175 can define action classes, activity classes, control flow classes, call behavior classes, etc. In this regard, each execution framework 175 can include static definitions for commonly used programming elements.

In operation, the deployment system 160 can receive the system model 150, for example in response to a user request, and process the system model 150 to generate corresponding program code. In this regard, the deployment system 160 can include a code generation engine 165 to generate the corresponding code. The code generation engine 165 can transform the system model, which may be expressed abstractly in diagram form (e.g., including abstractions such as statemachines, activities, parts, etc.), to a code-level model in accordance with UML and/or SysML (e.g., including only program language elements, such as classes, attributes, operations, etc.). The code generation engine 165 further can transform the code-level model into text, for example into one or more source code files comprising corresponding program code.

The deployment system 160 further can include a compiler 170. The compiler 170 can compile the source code files into one or more executable files 180. The compiler can include a linker that resolves function calls across an object file to output an executable file. When generating the executable files 180, the compiler 170 can access the execution framework 175 to utilize commonly defined library items, such as commonly used classes, attributes, operations, etc., thereby providing efficiently in the compilation process. In this regard, using the execution framework 175 can increase the speed of the compilation process in comparison to a compilation process in which execution framework 175 is not used. In addition, use of the execution framework 175 can result in less program code being generated in comparison to a system model being fully generated without use of the execution framework 175. In sum, use of the execution framework 175 results in shorter compilation and shorter code generation, thereby resulting in a highly efficient process.

The development system 160 can execute the executable files 180 to present an animated model of the activity diagrams 155 and control execution steps defined by the executable files 180. For example, the deployment system 160 can pause execution at various steps represented by the activity diagram to interactively receive and process the user inputs to test the system model 150. In this manner, a software/systems engineer or computer programmer can test and validate the system defined by the system model 150.

During execution of the executable files 180, the development system 160 also can validate the system model 150 (e.g., validate the program code generated by the code generation engine 165). The system can output a result of the validation. For example, the result can be output to, and stored within, the memory elements 110. As used herein, “outputting” and/or “output” can mean storing in the memory elements 110, for example, writing to a file stored in the memory elements 110, writing to the display 135 or other peripheral output device, playing audible notifications, sending or transmitting to another system, exporting, or the like.

In one embodiment, the workflow server can be implemented as IBM® Rational® Rhapsody® (IBM, Rational and Rhapsody are trademarks of International Business Machines Corporation in the United States, other countries, or both).

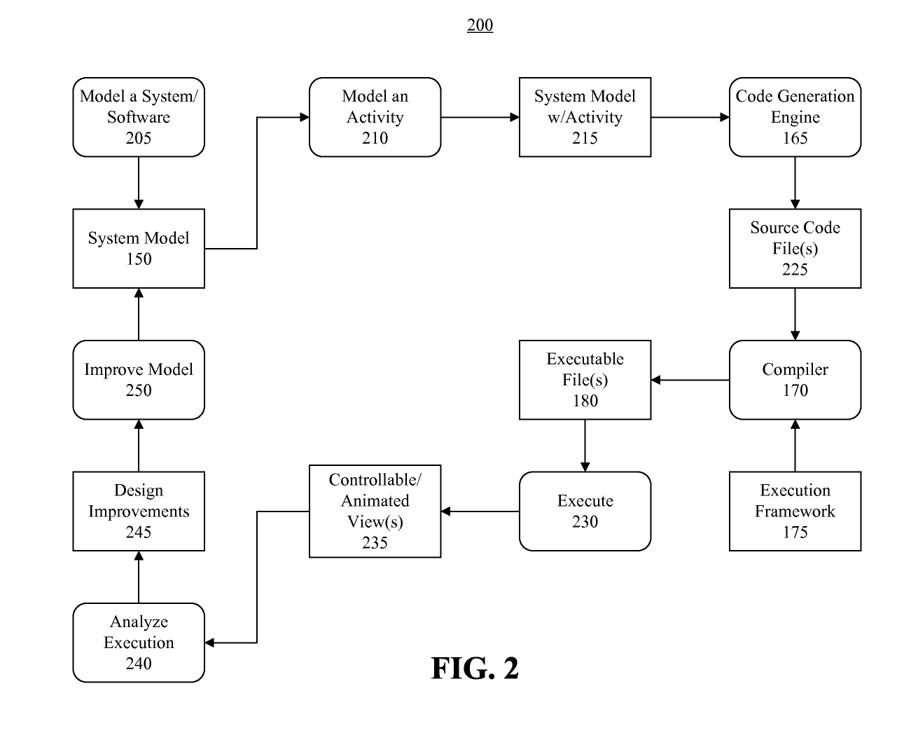

FIG. 2 is a flow diagram illustrating a process 200 of validating a system model in accordance with one embodiment of the present invention. Such process 200 can be implemented by the development system 160 (FIG. 1) to receive and validate the system model 150. At step 205, a user can model the system/software to generate the system model 150. As noted, the system model 150 can include at least one activity diagram.

At step 210, the activity represented by the activity diagram can be modeled to generate a version 215 system model 150 that includes the activity. Accordingly, the activity diagram can be processed to reflect the manner in which the activity diagram interacts with other design elements of the system model 150. Moreover, activity data can be dynamic in nature. By generating the version 215 system model 150 that includes the activity diagram, the dynamic nature of activity data can be incorporated into the system model 150, and thus the system model 150 can be validated using dynamic activity data.

The system model 215 can be passed to the code generation engine 165 (FIG. 1), which can process the system model 215 to generate one or more source code files 225, for example as previously described. The code generation engine 165 can pass the source code file(s) 225 to the compiler 170 to be processed to generate one or more executable files 180. As noted, the compiler 170 can access suitable execution framework 175 to utilize commonly defined library items during the compilation/linking process to increase the efficiency of such process.

At step 230, the executable file(s) 180 can be executed to generate one or more controllable/animated views 235 of the system model 150. At step 240, execution of the controllable/animated views 235 can be analyzed to validate the views 235.

The views 235 can be presented to a user via the display 135 (FIG. 1), and can be configured to receive user inputs testing the system model 150. For example, during execution, the development system 160 can present a view of the system model 150 based on the executable file(s) 180. The view can include event actions corresponding to the activity diagrams. The user can be prompted to enter parameters to be operated upon by the event actions, or default parameters can be provided. Moreover, the user can choose to send events, call operations or other user inputs to the executing system model 150, or control any interfaces that the executable file(s) 180 provide. Such user interaction can occur while the executable file(s) 180 are running in animation mode. In response to such user inputs or default parameters being received, the events/call operations or other user inputs can be executed. During execution, the system model 150 can be monitored to test the system model 150. Such testing can indicate exceptions that occur, values and/or parameters generated during execution, and the like.

In illustration, during testing, exceptions may be generated due to errors or defects in the system model 150. Such exceptions can be monitored, and error messages may be presented to the user. In addition to, or in lieu of, presenting error messages, an execution log can be generated to track the exceptions that are generated. The execution log also can indicate successful operation of the system model 150, parameters and/or values that are generated during the test, and/or any other information suitable for validation purposes. Moreover, values and/or parameters generated during the test can be presented to the user. Accordingly, the user can determine whether values and/or parameters generated during the test are appropriate for the intended functionality of the system model 150.

Based on the testing described, the user may opt to revise the system model 150. Accordingly, design improvements 245 to the system model 150 may be received from the user, and at step 250 the model can be improved to generate an updated version of the system model 150. The process 200 then can repeat, as desired by the user, until the user is satisfied with the system model 150.

At this point it should be noted that the system model 150 can be compiled and tested for deployment on a variety of different target execution platforms. By way of example, the user can choose the implementation programming language, e.g., C++, Java, etc., by configuring the code generation engine 165 and choosing the compiler 170, and the executable file(s) 180 can be generated accordingly. In this regard, the execution framework 175 accessed by the compiler 170 can be selected according to the programming language being used. Further, the execution environment in which the controllable/animated views 235 are presented also can be based on the programming language being used. For example, if the Java programming language is being used, a Java execution environment can be used.

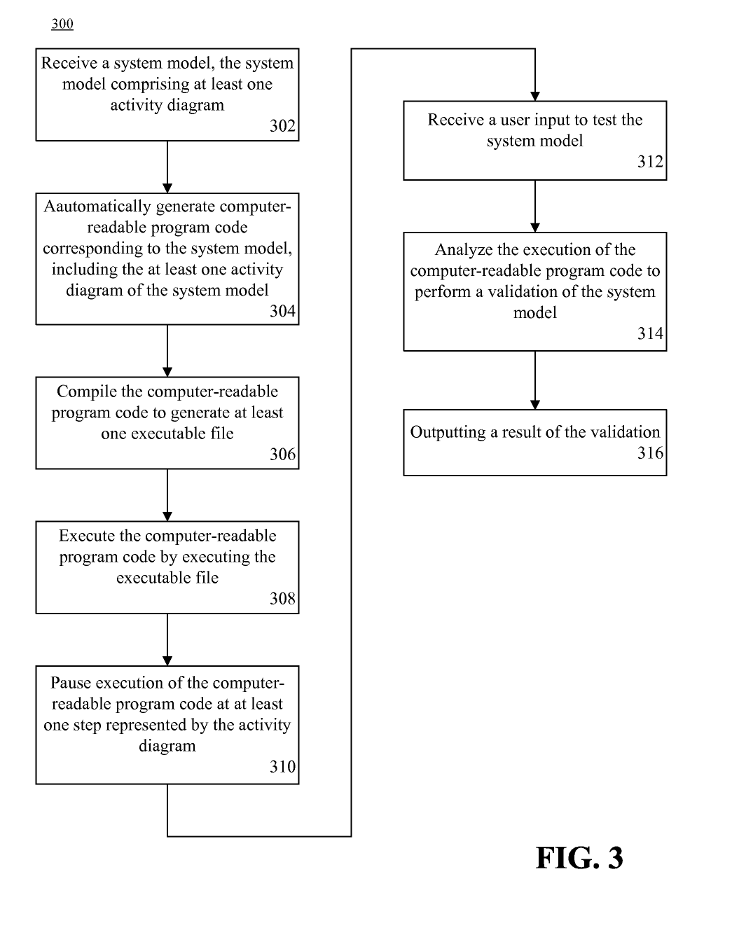

FIG. 3 is a flow chart illustrating a method 300 of validating a system model in accordance with one embodiment of the present invention. At step 302, a system model can be received. The system model can be a system model created by a user, such as a software/systems engineer or computer programmer. For example, the system model can be a UML or SysML system diagram. The system model can comprise at least one activity diagram.

At step 304, computer-readable program code corresponding to the system model can be generated. The computer-readable program code can include computer-readable program code corresponding to the at least one activity diagram of the system model. At step 306, the computer-readable program code can be compiled to generate at least one executable file. At step 308, the computer-readable program code can be executed, for example by executing the at least one executable file.

At step 310, execution of the computer-readable program code can be executed using incremental execution steps of various sizes. For example, the computer-readable program code can be executed until an action, such as a next action, indicated by the activity diagram is ready to receive an input, executed until a next action is ready and then paused, or executed until an event is received, or the like. At step 312, a user input can be received to test the system model. At step 314, execution of the computer-readable program code can be analyzed to perform a validation of the system model. At step 316, a result of the validation can be output.

Like numbers have been used to refer to the same items throughout this specification. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of validating a system model, the method comprising:
receiving the system model, the system model comprising at least one activity diagram;
via a processor, automatically generating computer-readable program code corresponding to the system model, including the at least one activity diagram of the system model;
executing the computer-readable program code;
analyzing execution of the computer-readable program code to perform a validation of the system model; and
outputting a result of the validation.

2. The method of claim 1, wherein:
automatically generating computer-readable program code comprises generating the computer-readable program code to further include other diagrams of the system model.

3. The method of claim 1, further comprising:
compiling the computer-readable program code to generate at least one executable file;
wherein executing the computer-readable program code comprises executing the at least one executable file.

4. The method of claim 3, wherein compiling the computer-readable program code to generate at least one executable file comprises:
accessing an execution framework comprising at least one library item to utilize the at least one library item during compilation of the at least one executable file.

5. The method of claim 1, wherein executing the computer-readable program code comprises:
presenting an animated model of the activity diagram.

6. The method of claim 5, further comprising:
pausing execution of the computer-readable program code until an action indicated by the activity diagram is ready to receive a user input or an event is received; and
receiving a user input to test the system model.

7. The method of claim 6, wherein analyzing execution of the computer-readable program code to perform the validation of the computer-readable program code comprises:
processing the user input to validate the computer-readable program code.

8. A method of validating a system model, the method comprising:
receiving the system model, the system model comprising at least one activity diagram;
via a processor, automatically generating computer-readable program code corresponding to the system model, including the at least one activity diagram of the system model;
compiling the computer-readable program code to generate at least one executable file;
executing the at least one executable file;
analyzing execution of the at least one executable file to perform a validation of the system model; and
outputting a result of the validation.

9. The method of claim 8, wherein compiling the computer-readable program code to generate at least one executable file comprises:
accessing an execution framework comprising at least one library item to utilize the at least one library item during compilation of the at least one executable file.

10. The method of claim 8, wherein executing the computer-readable program code comprises:
presenting an animated model of the activity diagram.

11. The method of claim 10, further comprising:
pausing execution at execution of the computer-readable program code until an action indicated by the activity diagram is ready to receive a user input or an event is received; and
receiving a user input to test the system model.

12-25. (canceled)
